(19) United States
(12) Patent Application Publication
(10) Pub. No.: US 2026/0042152 A1
(43) Pub. Date: Feb. 12, 2026

(54) EXTENDED BORING BAR CONNECTING APPARATUS BASED ON ZERO-POINT POSITIONING MECHANISMS

(71) Applicant: DALIAN UNIVERSITY OF TECHNOLOGY, Dalian (CN)

(72) Inventors: Zhi WANG, Dalian (CN); Qingkai JIANG, Dalian (CN); Hongwei SUN, Dalian (CN); Fuyan SUN, Dalian (CN); Guiyang NA, Dalian (CN)

(21) Appl. No.: 19/365,955

(22) Filed: Oct. 22, 2025

(30) Foreign Application Priority Data
Sep. 26, 2025 (CN) 202511385016.3

(51) Int. Cl. B23B 29/12

(52) U.S. Cl. CPC B23B 29/125

(57) ABSTRACT

The present invention discloses an extended boring bar connecting apparatus based on zero-point positioning mechanisms. A side surface of a power spindle box assembly is used as a connection base surface of a boring bar seat assembly, and an extended boring bar assembly is clamped in inner holes of hydraulic expansion sleeves of the boring bar seat assembly, and is also connected to a power spindle tool interface in the power spindle box assembly. A boring bar seat is locked to the side surface of the power spindle box assembly through zero-point positioning mechanisms. Two hydraulic expansion sleeves are arranged in an inner hole of the boring bar seat, and have dimensions corresponding to the diameter of an excircle where a boring bar is clamped. A tool holder interface flange of the boring bar assemblies is locked to the power spindle box assembly.

### TECHNICAL FIELD

The present invention belongs to the technical field of turning machining for inner holes of rotary workpieces, and relates to an extended boring bar connecting apparatus based on zero-point positioning mechanisms for turning and milling composite machine tools.

### BACKGROUND

Turning and milling composite machine tools can achieve multiple machining procedures such as turning, milling and boring via a single clamping of a workpiece, which avoids errors caused by repeated clamping of parts between different devices and achieves a high-efficiency and high-precision machining mode. Some parts have very deep inner holes. A tool for machining such inner holes generally has a length of more than one meter and a weight of more than 100 kilograms. This tool cannot be directly loaded onto a power tool spindle. It is often necessary to transfer the workpiece to another dedicated device for sequential machining, which not only increases the machining cycle, but also affects the machining precision due to repeated clamping. In order to expand the machining range of the machine tools and increase the machining efficiency of the parts, the existing turning and milling composite machine tools complete the machining of the deep holes of such parts by installing an extended boring bar on a side surface of a power tool spindle box. The connection between the extended boring bar and the power tool spindle box needs to satisfy the characteristics of simple and reliable structure, high clamping accuracy, and good vibration-reduction performance. The patent with the publication number CN216441671U mentions a connection mode in which a dovetail groove is used as a locking mechanism, but has many connection links, which has a certain impact on the connection rigidity. The patent does not clearly specify the clamping mode of a boring bar and a boring bar seat, cannot achieve precise axial positioning of the extended boring bar and lacks vibration-reduction measures.

Therefore, the present invention proposes an extended boring bar connecting apparatus based on zero-point positioning mechanisms, which directly connects a boring bar seat assembly to a side surface of a power tool spindle box. The extended boring bar assembly is also connected to a power spindle tool interface, thereby achieving angular and axial positioning of the boring bar. The boring bar is clamped in an inner hole of the boring bar seat by a hydraulic expansion sleeve. Compared with the traditional mode of pressing with screws, the present invention greatly enhances the clamping rigidity. This apparatus is also designed with a plurality of vibration-reduction mechanisms. Therefore, this extended boring bar connecting apparatus has excellent deep hole machining precision and vibration-reduction performance.

### SUMMARY

The present invention provides an extended boring bar connecting apparatus based on zero-point positioning mechanisms, which locks a boring bar seat to a side surface of a power spindle box through six sets of zero-point positioning mechanisms. Two hydraulic expansion sleeves are arranged in an inner hole of the boring bar seat, and have dimensions corresponding to the diameter of an excircle where a boring bar is clamped. Boring bar assemblies having the same diameter but different lengths are fastened in the boring bar seat through the hydraulic expansion sleeves, and a tool holder interface flange of the boring bar assemblies is locked to a power spindle, which plays an angular and axial positioning role for the extended boring bar assembly. Meanwhile, a plurality of vibration-reduction structures are also designed in the connecting apparatus, and can reduce the cutting vibration of an extended boring bar.

The technical solution of the present invention is as follows:

An extended boring bar connecting apparatus based on zero-point positioning mechanisms comprises a power spindle box assembly 1, a boring bar seat assembly 2 and an extended boring bar assembly 3; a side surface of the power spindle box assembly 1 is used as a connection base surface of the boring bar seat assembly 2, and the extended boring bar assembly 3 is clamped in inner holes of hydraulic expansion sleeves of the boring bar seat assembly 2, and is also connected to a power spindle tool interface 7 in the power spindle box assembly 1.

The side surface of the power spindle box assembly 1 is mainly composed of a side surface of a power spindle box 8 and an auxiliary positioning block 13; the side surface of the power spindle box 8 and the auxiliary positioning block 13 are located on a same plane on which a plurality of boring bar seat connecting zero-point positioning blind rivets 9 are distributed for connecting the boring bar seat assembly 2; a female end 10 of a hydraulic quick coupler and a female end 12 of a cutting fluid quick coupler are also arranged on the side surface of the power spindle box assembly 1, and are used respectively for providing hydraulic oil for the boring bar seat assembly 2 and providing cutting fluid for the extended boring bar assembly 3; and rubber vibration-reduction blocks 11 are also installed on the side surface of the power spindle box assembly 1 for vibration reduction after the connection of the boring bar seat assembly 2.

The connection base surface of the boring bar seat assembly 2 is a side surface of a boring bar seat 17, on which a plurality of boring bar seat connecting zero-point positioning chucks 15 are installed, and the boring bar seat connecting zero-point positioning chucks 15 correspond to the boring bar seat connecting zero-point positioning blind rivets 9 on the side surface of the power spindle box assembly 1; a male end 14 of the cutting fluid quick coupler and a male end 16 of the hydraulic quick coupler are also arranged on the connection base surface of the boring bar seat assembly 2, and correspond to the female end 12 of the cutting fluid quick coupler and the female end 10 of the hydraulic quick coupler on the connection base surface of the power spindle box assembly 1 respectively; two male ends 6 of pneumatic quick couplers are installed on opposite surfaces of the connection base surface of the boring bar seat assembly 2, and are communicated with the boring bar seat connecting zero-point positioning chucks 15 through a pipeline inside the boring bar seat 17; compressed air is introduced into the male ends 6 of the pneumatic quick couplers; after the boring bar seat connecting zero-point positioning chucks 15 are opened, the boring bar seat assembly 2 is loaded onto the power spindle box assembly 1 and the connection base surfaces of the two are made close together; then, the compressed air is disconnected from the male ends 6 of the pneumatic quick couplers, the boring bar seat connecting zero-point positioning chucks 15 are locked with the corresponding boring bar seat connecting zero-point positioning blind rivets 9, and the connection between the boring bar seat assembly 2 and the power spindle box assembly 1 is completed; at the same time, the male end 14 of the cutting fluid quick coupler is connected to the female end 12 of the cutting fluid quick coupler, and the male end 16 of the hydraulic quick coupler is connected to the female end 10 of the hydraulic quick coupler to form the cutting fluid quick coupler and the hydraulic quick coupler, and the hydraulic oil and the cutting fluid are conveyed from the power spindle box assembly 1 through the cutting fluid quick coupler and the hydraulic quick coupler into the boring bar seat assembly 2 for the locking of the extended boring bar assembly 3 and the central water discharge of an extended boring bar 27 next.

A front hydraulic expansion sleeve 21 and a rear hydraulic expansion sleeve 18 are assembled inside the boring bar seat 17, and are correspondingly installed on a front end surface and a rear end surface of the boring bar seat 17; the front hydraulic expansion sleeve 21 and the rear hydraulic expansion sleeve 18 form two hydraulic oil chambers with an inner hole of the boring bar seat 17 through a star sealing ring 20, and the two hydraulic oil chambers are communicated with the male end 16 of the hydraulic quick coupler through the pipeline inside the boring bar seat 17; an internal cooling end cover 25 is installed at a rear end of the boring bar seat 17, and a spring oscillator vibration-reduction mechanism is arranged in the internal cooling end cover 25, and absorbs the cutting vibration of the extended boring bar assembly 3 through the resonance of the spring oscillator vibration-reduction mechanism; a male end 26 of a central water discharge quick coupler is also installed in the internal cooling end cover 25, and is communicated with the male end 14 of the cutting fluid quick coupler through an internal pipeline of the boring bar seat assembly 2; boring bar seat storing zero-point positioning blind rivets 5 and the male ends 6 of the pneumatic quick couplers are installed on another side surface parallel to the connection base surface of the boring bar seat assembly 2; the boring bar seat storing zero-point positioning blind rivets 5 provide a positioning reference for the automatic exchange of the boring bar seat assembly 2, and the male ends 6 of the pneumatic quick couplers are used for communicating with the compressed air opened by the boring bar seat connecting zero-point positioning chucks 15.

The extended boring bar assembly 3 is mainly composed of an extended boring bar 27 with a built-in vibration-reduction unit, a boring bar installing plate 33, and a tool holder interface flange 34; the extended boring bar 27 is fastened to the boring bar installing plate 33 through a gland 29 and a locking expansion sleeve 30; two O-rings 32 are installed at a matching point between the boring bar installing plate 33 and an outer circle of the extended boring bar 27; a hydraulic oil film 31 is filled between the two O-rings 32; a piston 36 is provided with a sealing ring 37; the piston 36 moves in an oil chamber of the boring bar installing plate 33 and seals the hydraulic oil film 31; a pressure regulating screw 35 is tightened in the boring bar installing plate 33 through threads and comes into contact with the piston 36; the pressure of the hydraulic oil film 31 is regulated by pressing the piston 36 with the pressure regulating screw 35, and the cutting vibration transmitted by a tool tip of the extended boring bar 27 is further attenuated through the built-in vibration-reduction unit at a front end and then through two sets of O-rings 32 and the high-pressure hydraulic oil film 31; the tool holder interface flange 34 is installed at the other end of the boring bar installing plate 33; a female end 28 of the central water discharge quick coupler is installed at a rear end of the extended boring bar 27, and is matched with the male end 26 of the central water discharge quick coupler in the internal cooling end cover 25; two extended boring bar storing zero-point positioning blind rivets 4 are also installed on the boring bar installing plate 33, and the extended boring bar storing zero-point positioning blind rivets 4 provide a positioning reference for the automatic exchange of the extended boring bar assembly 3.

Rubber vibration-reduction seats 19 are also installed on the side surface of the boring bar seat 17; and after the power spindle box assembly 1 is connected to the boring bar seat assembly 2, the rubber vibration-reduction seats 19 are tightly matched with the rubber vibration-reduction blocks 11 to increase the shear damping of the connection base surface and reduce the cutting vibration of the extended boring bar assembly 3.

A pressure measuring joint 38 is also installed on the pipeline inside the boring bar seat 17, and is used for pressure detection and air discharge in the hydraulic oil chambers.

The spring oscillator vibration-reduction mechanism is mainly composed of tension springs 22, bolts 23 and a spring oscillator 24; four bolts 23 are evenly distributed along a circumference and installed on an end surface of an inner hole of the internal cooling end cover 25; and one end of four tension springs 22 is hung on the bolts 23, and the other end is hung on the spring oscillator 24.

When the extended boring bar assembly 3 is connected, first, the boring bar seat assembly 2 completes connection to the power spindle box assembly 1; then, the power spindle box assembly 1 is put in a tool-loosening state, and next, moves along an axis of the extended boring bar 27 towards the extended boring bar assembly 3 to allow a rear end of the extended boring bar 27 to enter inner holes of the front hydraulic expansion sleeve 21 and the rear hydraulic expansion sleeve 18; the tool holder interface flange 34 is also combined with the power spindle tool interface 7 on the power spindle box assembly 1; then, the power spindle box assembly 1 is put in a tool-broaching state, and the tool holder interface flange 34 is locked to the power spindle tool interface 7; finally, the hydraulic oil is supplied to the hydraulic oil chambers of the front hydraulic expansion sleeve 21 and the rear hydraulic expansion sleeve 18 through the female end 10 of the hydraulic quick coupler and the male end 16 of the hydraulic quick coupler, which are communicated with each other, causing the thin-walled inner holes of the front hydraulic expansion sleeve 21 and the rear hydraulic expansion sleeve 18 to deform, to complete the clamping connection of the cylindrical tool holder at the rear end of the extended boring bar 27; at this point, the high-precision connection of the extended boring bar assembly 3 is completed through the front hydraulic expansion sleeve 21, the rear hydraulic expansion sleeve 18, and the power spindle tool interface 7. After the connection of the extended boring bar assembly 3 is completed, the female end 28 of the central water discharge quick coupler at the rear end of the extended boring bar 27 is also communicated with the male end 26 of the central water discharge quick coupler at the rear end of the boring bar seat assembly 2, and the cutting fluid can enter the internal cooling end cover 25 through the female end 12 of the cutting fluid quick coupler and the male end 14 of the cutting fluid quick coupler, which are communicated with each other, and then enter an internal cooling channel of the extended boring bar 27 via the male end 26 of the central water discharge quick coupler and the female end 28 of the central water discharge quick coupler to reach a cutting region of the tool tip directly.

The present invention has the following beneficial effects:
1. The high-rigidity locking of the extended boring bar with the standard cylindrical tool holder is achieved. By introducing the boring bar seat assembly, the extended boring bars with different length-to-diameter ratios can be adapted without the need to customize an extended boring bar with a non-standard interface. Meanwhile, the hydraulic expansion sleeves inside the boring bar seat assembly achieve extremely high locking stiffness for the outside diameter of the boring bar.
2. A high-precision connection base surface based on zero-point positioning mechanisms is invented. By making full use of the structural characteristics, the zero-point positioning blind rivets are installed on the side surface of the power spindle box, thereby expanding an installation base surface to the maximum extent and reliably ensuring the connection rigidity and precision. A gas path for opening the zero-point positioning chucks is introduced from the boring bar seat through the quick coupler, which avoids adding a complex pipeline in the power spindle box and also providing structural feasibility for the automatic exchange of the extended boring bar.
3. A variety of vibration-reduction mechanisms suitable for the extended boring bar are invented, including pre-tightening vibration reduction between the two O-rings at the foremost end and the cylindrical surface of the boring bar, and the attenuation of vibration energy by the hydraulic oil films; further attenuation of the vibration through the damping within the structure by two high-damping vibration-reduction rubber seats; the direct absorption of the vibration of a boring bar body by the two annular hydraulic locking expansion sleeves; and the spring oscillator vibration-reduction mechanism at the rearmost end of the boring bar seat assembly, which absorbs the cutting vibration transmitted by the boring bar through the resonance. Through these structural inventions, the cutting capacity of the extended boring bar assembly is essentially enhanced.

### DESCRIPTION OF DRAWINGS

FIG. 1 is a schematic diagram of connection of an extended boring bar.

FIG. 2 is a layout diagram of a connection base surface of a power spindle box assembly.

FIG. 3 is a layout diagram of a connection base surface of a boring bar seat assembly.

FIG. 4 is an A-A sectional view of FIG. 3.

FIG. 5 is a B-B sectional view of FIG. 4.

FIG. 6 is a C-C sectional view of FIG. 4.

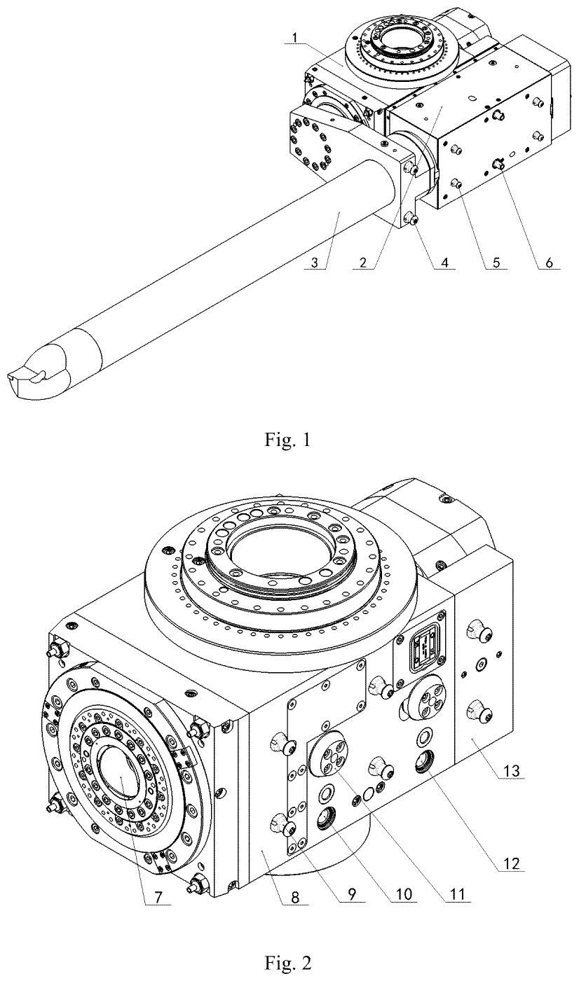

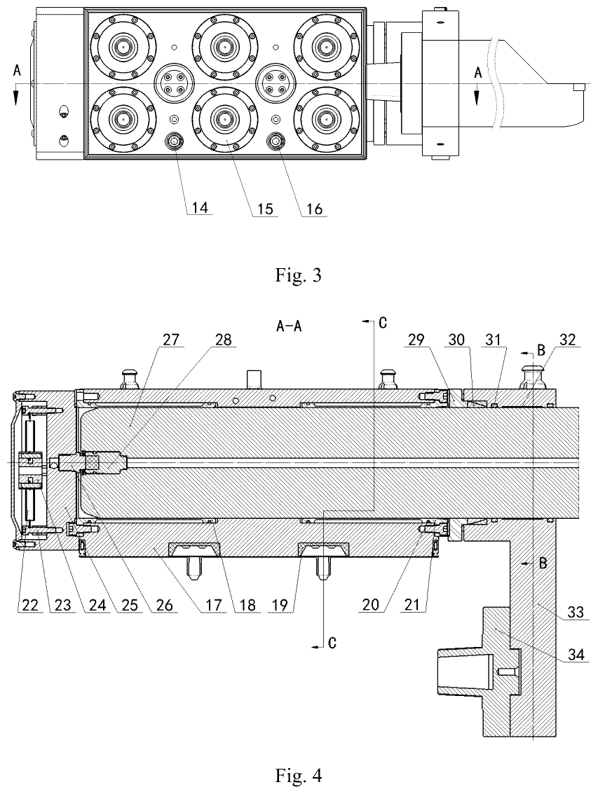

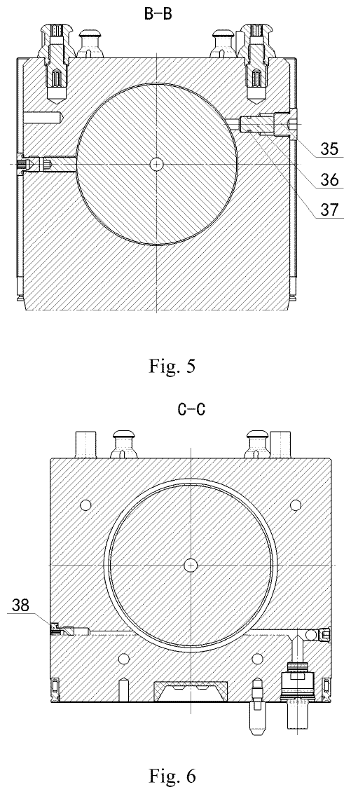

In the figures: 1 power spindle box assembly; 2 boring bar seat assembly; 3 extended boring bar assembly; 4 extended boring bar storing zero-point positioning blind rivet; 5 boring bar seat storing zero-point positioning blind rivet; 6 male end of pneumatic quick coupler; 7 power spindle tool interface; 8 power spindle box; 9 boring bar seat connecting zero-point positioning blind rivet; 10 female end of hydraulic quick coupler; 11 rubber vibration-reduction block; 12 female end of cutting fluid quick coupler; 13 auxiliary positioning block; 14 male end of cutting fluid quick coupler; 15 boring bar seat connecting zero-point positioning chuck; 16 male end of hydraulic quick coupler; 17 boring bar seat; 18 rear hydraulic expansion sleeve; 19 rubber vibration-reduction seat; 20 star sealing ring; 21 front hydraulic expansion sleeve; 22 tension spring; 23 bolt; 24 spring oscillator; 25 internal cooling end cover; 26 male end of central water discharge quick coupler; 27 extended boring bar; 28 female end of central water discharge quick coupler; 29 gland; 30 locking expansion sleeve; 31 hydraulic oil film; 32 O-ring; 33 boring bar installing plate; 34 tool holder interface flange; 35 pressure regulating screw; 36 piston; 37 sealing ring; 38 pressure measuring joint.

### DETAILED DESCRIPTION

Specific embodiments of the present invention are further described below in combination with the drawings and the technical solution.

An extended boring bar connecting apparatus based on zero-point positioning mechanisms comprises a connection base surface based on zero-point positioning mechanisms, a clamping mechanism which uses hydraulic expansion sleeves, and a tool holder interface flange locked by a power spindle; a side surface of the power spindle box assembly 1 is used as a connection base surface of the boring bar seat assembly 2, and the extended boring bar assembly 3 is clamped in inner holes of hydraulic expansion sleeves of the boring bar seat assembly 2, and is also connected to a power spindle tool interface 7 in the power spindle box assembly 1.

The side surface of the power spindle box assembly 1 is mainly composed of a side surface of a power spindle box 8 and an auxiliary positioning block 13; the side surface of the power spindle box 8 and the auxiliary positioning block 13 are located on a same plane on which a plurality of boring bar seat connecting zero-point positioning blind rivets 9 are distributed for connecting the boring bar seat assembly 2; a female end 10 of a hydraulic quick coupler and a female end 12 of a cutting fluid quick coupler are also arranged on the side surface of the power spindle box assembly 1, and are used respectively for providing hydraulic oil for the boring bar seat assembly 2 and providing cutting fluid for the extended boring bar assembly 3; and rubber vibration-reduction blocks 11 are also installed on the side surface of the power spindle box assembly 1 for vibration reduction after the connection of the boring bar seat assembly 2.

The connection base surface of the boring bar seat assembly 2 is arranged on a side surface of a boring bar seat 17, on which a plurality of boring bar seat connecting zero-point positioning chucks 15 are installed and correspond to the boring bar seat connecting zero-point positioning blind rivets 9 on the side surface of the power spindle box assembly 1; a male end 14 of the cutting fluid quick coupler and a male end 16 of the hydraulic quick coupler are also arranged on the connection base surface of the boring bar seat 17, and correspond to the female end 12 of the cutting fluid quick coupler and the female end 10 of the hydraulic quick coupler on the connection base surface of the power spindle box assembly 1 respectively; two male ends 6 of pneumatic quick couplers are installed on opposite surfaces of the connection base surface of the boring bar seat assembly 2, and are communicated with the boring bar seat connecting zero-point positioning chucks 15 through a pipeline inside the boring bar seat 17; compressed air is inputted into the male ends 6 of the pneumatic quick couplers; after the boring bar seat connecting zero-point positioning chucks 15 are opened, the boring bar seat assembly 2 is loaded onto the power spindle box assembly 1 and the connection base surfaces of the two are made close together; then, the compressed air connected to the male ends 6 of the pneumatic quick couplers is disconnected, the boring bar seat connecting zero-point positioning chucks 15 are locked with the corresponding boring bar seat connecting zero-point positioning blind rivets 9, and the connection between the boring bar seat assembly 2 and the power spindle box assembly 1 is completed; at the same time, the male end 14 of the cutting fluid quick coupler is connected to the female end 12 of the cutting fluid quick coupler, and the male end 16 of the hydraulic quick coupler is connected to the female end 10 of the hydraulic quick coupler to form the cutting fluid quick coupler and the hydraulic quick coupler, and the hydraulic oil and the cutting fluid are conveyed from the power spindle box assembly 1 through the cutting fluid quick coupler and the hydraulic quick coupler into the boring bar seat assembly 2 for the locking of the extended boring bar assembly 3 and the central water discharge of an extended boring bar 27 next; rubber vibration-reduction seats 19 are also installed on the side surface of the boring bar seat 17; and after the power spindle box assembly 1 is connected to the boring bar seat assembly 2, the rubber vibration-reduction seats 19 are tightly matched with the rubber vibration-reduction blocks 11 to increase the shear damping of the connection base surface and reduce the cutting vibration of the extended boring bar assembly 3.

A front hydraulic expansion sleeve 21 and a rear hydraulic expansion sleeve 18 are assembled inside the boring bar seat 17, and are correspondingly installed on a front end surface and a rear end surface of the boring bar seat 17; the front hydraulic expansion sleeve 21 and the rear hydraulic expansion sleeve 18 form two hydraulic oil chambers with an inner hole of the boring bar seat 17 through a star sealing ring 20, and the two hydraulic oil chambers are communicated with the male end 16 of the hydraulic quick coupler through the pipeline inside the boring bar seat 17; a pressure measuring joint 38 is also installed on the pipeline inside the boring bar seat 17, and is used for pressure detection and air discharge in the hydraulic oil chambers; an internal cooling end cover 25 is installed at a rear end of the boring bar seat 17, and a spring oscillator vibration-reduction mechanism is arranged in the internal cooling end cover 25; the spring oscillator vibration-reduction mechanism is mainly composed of tension springs 22, bolts 23 and a spring oscillator 24; four bolts 23 are evenly distributed along a circumference and installed on an end surface of an inner hole of the internal cooling end cover 25; and one end of four tension springs 22 is hung on the bolts 23, and the other end is hung on the spring oscillator 24. The cutting vibration of the extended boring bar assembly 3 is absorbed through the resonance of the spring oscillator 24; a male end 26 of a central water discharge quick coupler is also installed in the internal cooling end cover 25, and is communicated with the male end 14 of the cutting fluid quick coupler through an internal pipeline of the boring bar seat assembly 2; boring bar seat storing zero-point positioning blind rivets 5 and the male ends 6 of the pneumatic quick couplers are installed on another side surface parallel to the connection base surface of the boring bar seat assembly 2; the boring bar seat storing zero-point positioning blind rivets 5 provide a positioning reference for the automatic exchange of the boring bar seat assembly 2, and the male ends 6 of the pneumatic quick couplers are used for communicating with the compressed air opened by the boring bar seat connecting zero-point positioning chucks 15.

The extended boring bar assembly 3 is mainly composed of an extended boring bar 27 with a built-in vibration-reduction unit, a boring bar installing plate 33, and a tool holder interface flange 34; the extended boring bar 27 is fastened to the boring bar installing plate 33 through a gland 29 and a locking expansion sleeve 30; two O-rings 32 are installed at a matching point between the boring bar installing plate 33 and an outer circle of the extended boring bar 27; a hydraulic oil film 31 is filled between the two O-rings 32; a piston 36 is provided with a sealing ring 37; the piston 36 moves in an oil chamber of the boring bar installing plate 33 and seals the hydraulic oil film 31; a pressure regulating screw 35 is tightened in the boring bar installing plate 33 through threads and comes into contact with the piston 36; the pressure of the hydraulic oil film 31 is regulated by pressing the piston 36 with the pressure regulating screw 35, and the cutting vibration transmitted by a tool tip of the extended boring bar 27 is further attenuated through the built-in vibration-reduction unit at a front end and then through two sets of O-rings 32 and the high-pressure hydraulic oil film 31; the tool holder interface flange 34 is installed at the other end of the boring bar installing plate 33; a female end 28 of the central water discharge quick coupler is installed at a rear end of the extended boring bar 27, and is matched with the male end 26 of the central water discharge quick coupler in the internal cooling end cover 25; two extended boring bar storing zero-point positioning blind rivets 4 are also installed on the boring bar installing plate 33, and the extended boring bar storing zero-point positioning blind rivets 4 provide a positioning reference for the automatic exchange of the extended boring bar assembly 3.

When the extended boring bar assembly 3 is connected, first, the boring bar seat assembly 2 completes connection to the power spindle box assembly 1; then, the power spindle box assembly 1 is put in a tool-loosening state, and next, moves along an axis of the extended boring bar 27 towards the extended boring bar assembly 3 to allow a rear end of the extended boring bar 27 to enter inner holes of the front hydraulic expansion sleeve 21 and the rear hydraulic expansion sleeve 18; the tool holder interface flange 34 is also combined with the power spindle tool interface 7 on the power spindle box assembly 1; then, the power spindle box assembly 1 is put in a tool-broaching state, and the tool holder interface flange 34 is locked to the power spindle tool interface 7; finally, the hydraulic oil is supplied to the hydraulic oil chambers of the front hydraulic expansion sleeve 21 and the rear hydraulic expansion sleeve 18 through the female end 10 of the hydraulic quick coupler and the male end 16 of the hydraulic quick coupler, which are communicated with each other, causing the thin-walled inner holes of the front hydraulic expansion sleeve 21 and the rear hydraulic expansion sleeve 18 to deform, to complete the clamping connection of the cylindrical tool holder at the rear end of the extended boring bar 27; at this point, the high-precision connection of the extended boring bar assembly 3 is completed through the front hydraulic expansion sleeve 21, the rear hydraulic expansion sleeve 18, and the power spindle tool interface 7. After the connection of the extended boring bar assembly 3 is completed, the female end 28 of the central water discharge quick coupler at the rear end of the extended boring bar 27 is also communicated with the male end 26 of the central water discharge quick coupler at the rear end of the boring bar seat assembly 2, and the cutting fluid can enter the internal cooling end cover 25 through the female end 12 of the cutting fluid quick coupler and the male end 14 of the cutting fluid quick coupler, which are communicated with each other, and then enter an internal cooling channel of the extended boring bar 27 via the male end 26 of the central water discharge quick coupler and the female end 28 of the central water discharge quick coupler to reach a cutting region of the tool tip directly.

1. An extended boring bar connecting apparatus based on zero-point positioning mechanisms, comprising a power spindle box assembly (1), a boring bar seat assembly (2) and an extended boring bar assembly (3), wherein a side surface of the power spindle box assembly (1) is used as a connection base surface of the boring bar seat assembly (2), and the extended boring bar assembly (3) is clamped in inner holes of hydraulic expansion sleeves of the boring bar seat assembly (2), and is also connected to a power spindle tool interface (7) in the power spindle box assembly (1); wherein
the side surface of the power spindle box assembly (1) is mainly composed of a side surface of a power spindle box (8) and an auxiliary positioning block (13); the side surface of the power spindle box (8) and the auxiliary positioning block (13) are located on a same plane on which a plurality of boring bar seat connecting zero-point positioning blind rivets (9) are distributed for connecting the boring bar seat assembly (2); a female end (10) of a hydraulic quick coupler and a female end (12) of a cutting fluid quick coupler are also arranged on the side surface of the power spindle box assembly (1), and are used respectively for providing hydraulic oil for the boring bar seat assembly (2) and providing cutting fluid for the extended boring bar assembly (3); and rubber vibration-reduction blocks (11) are also installed on the side surface of the power spindle box assembly (1) for vibration reduction after the connection of the boring bar seat assembly (2).

2. The extended boring bar connecting apparatus based on zero-point positioning mechanisms according to claim 1, wherein
the connection base surface of the boring bar seat assembly (2) is a side surface of a boring bar seat (17), on which a plurality of boring bar seat connecting zero-point positioning chucks (15) are installed, and the boring bar seat connecting zero-point positioning chucks (15) correspond to the boring bar seat connecting zero-point positioning blind rivets (9) on the side surface of the power spindle box assembly (1); a male end (14) of the cutting fluid quick coupler and a male end (16) of the hydraulic quick coupler are also arranged on the connection base surface of the boring bar seat assembly (2), and correspond to the female end (12) of the cutting fluid quick coupler and the female end (10) of the hydraulic quick coupler on the connection base surface of the power spindle box assembly (1) respectively; two male ends (6) of pneumatic quick couplers are installed on opposite surfaces of the connection base surface of the boring bar seat assembly (2), and are communicated with the boring bar seat connecting zero-point positioning chucks (15) through a pipeline inside the boring bar seat (17); compressed air is introduced into the male ends (6) of the pneumatic quick couplers; after the boring bar seat connecting zero-point positioning chucks (15) are opened, the boring bar seat assembly (2) is loaded to the power spindle box assembly (1) and the connection base surfaces of the two are made close together; then, the compressed air is disconnected from the male ends (6) of the pneumatic quick couplers, the boring bar seat connecting zero-point positioning chucks (15) are locked with the corresponding boring bar seat connecting zero-point positioning blind rivets (9), and the connection between the boring bar seat assembly (2) and the power spindle box assembly (1) is completed; at the same time, the male end (14) of the cutting fluid quick coupler is connected to the female end (12) of the cutting fluid quick coupler, and the male end (16) of the hydraulic quick coupler is connected to the female end (10) of the hydraulic quick coupler to form the cutting fluid quick coupler and the hydraulic quick coupler, and the hydraulic oil and the cutting fluid are conveyed from the power spindle box assembly (1) through the cutting fluid quick coupler and the hydraulic quick coupler into the boring bar seat assembly (2) for the locking of the extended boring bar assembly (3) and the central water discharge of an extended boring bar (27) next;
a front hydraulic expansion sleeve (21) and a rear hydraulic expansion sleeve (18) are assembled inside the boring bar seat (17), and are correspondingly installed on a front end surface and a rear end surface of the boring bar seat (17); the front hydraulic expansion sleeve (21) and the rear hydraulic expansion sleeve (18) form two hydraulic oil chambers with an inner hole of the boring bar seat (17) through a star sealing ring (20), and the two hydraulic oil chambers are communicated with the male end (16) of the hydraulic quick coupler through the pipeline inside the boring bar seat (17); an internal cooling end cover (25) is installed at a rear end of the boring bar seat (17), and a spring oscillator vibration-reduction mechanism is arranged in the internal cooling end cover (25), and absorbs the cutting vibration of the extended boring bar assembly (3) through the resonance of the spring oscillator vibration-reduction mechanism; a male end (26) of a central water discharge quick coupler is also installed in the internal cooling end cover (25), and is communicated with the male end (14) of the cutting fluid quick coupler through an internal pipeline of the boring bar seat assembly (2); boring bar seat storing zero-point positioning blind rivets (5) and the male ends (6) of the pneumatic quick couplers are installed on another side surface parallel to the connection base surface of the boring bar seat assembly (2); the boring bar seat storing zero-point positioning blind rivets (5) provide a positioning reference for the automatic exchange of the boring bar seat assembly (2), and the male ends (6) of the pneumatic quick couplers are used for communicating with the compressed air opened by the boring bar seat connecting zero-point positioning chucks (15).

3. The extended boring bar connecting apparatus based on zero-point positioning mechanisms according to claim 2, wherein
the extended boring bar assembly (3) is mainly composed of an extended boring bar (27) with a built-in vibration-reduction unit, a boring bar installing plate (33), and a tool holder interface flange (34); the extended boring bar (27) is fastened to the boring bar installing plate (33) through a gland (29) and a locking expansion sleeve (30); two O-rings (32) are installed at a matching point between the boring bar installing plate (33) and an outer circle of the extended boring bar (27); a hydraulic oil film (31) is filled between the two O-rings (32); a piston (36) is provided with a sealing ring (37); the piston (36) moves in an oil chamber of the boring bar installing plate (33) and seals the hydraulic oil film (31); a pressure regulating screw (35) is tightened in the boring bar installing plate (33) through threads and comes into contact with the piston (36); the pressure of the hydraulic oil film (31) is regulated by pressing the piston (36) with the pressure regulating screw (35), and the cutting vibration transmitted by a tool tip of the extended boring bar (27) is further attenuated through the built-in vibration-reduction unit at a front end and then through two sets of O-rings (32) and the high-pressure hydraulic oil film (31); the tool holder interface flange (34) is installed at the other end of the boring bar installing plate (33); a female end (28) of the central water discharge quick coupler is installed at a rear end of the extended boring bar (27), and is matched with the male end (26) of the central water discharge quick coupler in the internal cooling end cover (25); two extended boring bar storing zero-point positioning blind rivets (4) are also installed on the boring bar installing plate (33), and the extended boring bar storing zero-point positioning blind rivets (4) provide a positioning reference for the automatic exchange of the extended boring bar assembly (3).

4. The extended boring bar connecting apparatus based on zero-point positioning mechanisms according to claim 3, wherein
rubber vibration-reduction seats (19) are also installed on the side surface of the boring bar seat (17); and after the power spindle box assembly (1) is connected to the boring bar seat assembly (2), the rubber vibration-reduction seats (19) are tightly matched with the rubber vibration-reduction blocks (11) to increase the shear damping of the connection base surface and reduce the cutting vibration of the extended boring bar assembly (3).

5. The extended boring bar connecting apparatus based on zero-point positioning mechanisms according to claim 4, wherein
a pressure measuring joint (38) is also installed on the pipeline inside the boring bar seat (17), and is used for pressure detection and air discharge in the hydraulic oil chambers.

6. The extended boring bar connecting apparatus based on zero-point positioning mechanisms according to claim 5, wherein
the spring oscillator vibration-reduction mechanism is mainly composed of tension springs (22), bolts (23) and a spring oscillator (24); four bolts (23) are evenly distributed along a circumference and installed on an end surface of an inner hole of the internal cooling end cover (25); and one end of four tension springs (22) is hung on the bolts (23), and the other end is hung on the spring oscillator (24).

7. The extended boring bar connecting apparatus based on zero-point positioning mechanisms according to claim 6, wherein
when the extended boring bar assembly (3) is connected, first, the boring bar seat assembly (2) completes connection to the power spindle box assembly (1); then, the power spindle box assembly (1) is put in a tool-loosening state, and next, moves along an axis of the extended boring bar (27) towards the extended boring bar assembly (3) to allow a rear end of the extended boring bar (27) to enter inner holes of the front hydraulic expansion sleeve (21) and the rear hydraulic expansion sleeve (18); the tool holder interface flange (34) is also combined with the power spindle tool interface (7) on the power spindle box assembly (1); then, the power spindle box assembly (1) is put in a tool-broaching state, and the tool holder interface flange (34) is locked to the power spindle tool interface (7); finally, the hydraulic oil is supplied to the hydraulic oil chambers of the front hydraulic expansion sleeve (21) and the rear hydraulic expansion sleeve (18) through the female end (10) of the hydraulic quick coupler and the male end (16) of the hydraulic quick coupler, which are communicated with each other, causing the thin-walled inner holes of the front hydraulic expansion sleeve (21) and the rear hydraulic expansion sleeve (18) to deform, to complete the clamping connection of the cylindrical tool holder at the rear end of the extended boring bar (27); at this point, the high-precision connection of the extended boring bar assembly (3) is completed through the front hydraulic expansion sleeve (21), the rear hydraulic expansion sleeve (18), and the power spindle tool interface (7); after the connection of the extended boring bar assembly (3) is completed, the female end (28) of the central water discharge quick coupler at the rear end of the extended boring bar (27) is also communicated with the male end (26) of the central water discharge quick coupler at the rear end of the boring bar seat assembly (2), and the cutting fluid can enter the internal cooling end cover (25) through the female end (12) of the cutting fluid quick coupler and the male end (14) of the cutting fluid quick coupler, which are communicated with each other, and then enter an internal cooling channel of the extended boring bar (27) via the male end (26) of the central water discharge quick coupler and the female end (28) of the central water discharge quick coupler to reach a cutting region of the tool tip directly.
